(19) United States
(12) Patent Application Publication
(10) Pub. No.: US 2008/0041198 A1
(43) Pub. Date: Feb. 21, 2008

(54) Tool for applying and removing a band clamp

(76) Inventor: Pi-Liang Wu, Taichung (TW)

Correspondence Address: PI-LIANG WU, P.O.BOX 55-124, TAICHUNG, omitted

(21) Appl. No.: 11/524,458

(22) Filed: Sep. 21, 2006

(30) Foreign Application Priority Data
Aug. 21, 2006 (TW) 095214761

(51) Int. Cl. B25B 25/00; B25B 11/00

(52) U.S. Cl. 81/486

(57) ABSTRACT

A tool for applying and removing a band clamp includes two parts pivotably and crossly connected with each other, and each part has a connection section to which an applying member is rotatably connected thereto, and a handle section to which a grip is connected. Each applying member has a first working end and a second working end. The first working end has an inclined surface and a recess is defined in the inclined surface. The second working end is a plate. The two applying members are located such that the first working end of one applying member faces the second working end of the other applying member. By rotating the applying members, the two applying members can reach the band clamp at different angles.

### FIELD OF THE INVENTION

The present invention relates to a tool with two rotatable applying members so as to fasten or unfasten the band clamp at different angles.

### BACKGROUND OF THE INVENTION

A band clamp such as developed by French company Caillau is shown in FIG. 1 and generally is a non-closed ring with a hook portion 1 at a first end of the ring and a protrusion 2 extends from the outer periphery of a second end of the ring. Two tubular objects can be fastened by the band clamp by hooking the hook portion 1 with the protrusion 2. The band clamp is made by metal plate and includes a reinforcement plate 3 which is located beside the root portion of the hook portion 1 so as to reinforce the structural strength of the hook portion 1. When using the band clamp, a tool is used and disclosed in FIGS. 2 and 3, the tool includes a first arm 4, a second arm 5 which is pivotably connected to the first arm 4 by a pin 6. Two grips 8 are connected to the first and second arms 4, 5. A torsion spring 7 is located between the first and second arms 4 and 5, and includes a ring portion 702 through which the pin 6 extends and the two legs of the torsion spring 7 are in contact with the first and second arms 4, 5 to keep the two grips 8 normally opened. The first arm 4 has a first applying member 402 connected thereto and the second arm 5 has a second applying member 502 connected thereto. The first applying member 402 includes an inclined surface 404 which faces the second applying member 502. A recess 406 is defined through the inclined surface 404.

When using the tool, the first and second applying members 402, 502 are respectively engaged with the hook portion 1 and the protrusion 2, and first and second arms 4, 5 are then squeezed to move the hook portion 1 and the protrusion 2 toward each other till the hook portion 1 with the protrusion 2. When releasing the fattener, the first and second applying members 4, 5 are then respectively engaged with the protrusion 2 and the hook portion 1 and the two grips 8 are then squeezed, the inclined surface 404 pushes the hook portion 1 to disengage from the protrusion 2.

Nevertheless, the first and second applying members 402, 502 are fixed to the first and second arms 4 and 5 so that when there is only a narrow space around the band clamp, the conventional tool might be able to reach the hook portion 2 and the protrusion 2.

The present invention intends to provide a tool for applying and removing a band clamp wherein the applying members can be rotated an angle to conveniently reach the band clamp from different angles.

### SUMMARY OF THE INVENTION

The present invention relates to a tool for applying and removing a band clamp comprises two parts which are pivotably connected with each other by a pin and each part has a connection section and a handle section. Two applying members are respectively and pivotably connected to the two respective connection sections of the two parts. Each applying member has a first working end and a second working end. The first working end has an inclined surface and a recess is defined in the inclined surface. The second working end is a plate. The two applying members are located such that the first working end of one applying member faces the second working end of the other applying member.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the conventional band clamp;

FIG. 2 shows the conventional tool for applying and removing the band clamp;

FIG. 3 is an exploded view to show the conventional tool as shown in FIG. 2;

FIG. 4 is an exploded view to show the tool for applying and removing a band clamp of the present invention;

FIG. 5 is an exploded view to show the tool for applying and removing a band clamp of the present invention, and

FIGS. 6 and 7 show that the applying members are pivotable relative to the two parts of the tool of the present invention.

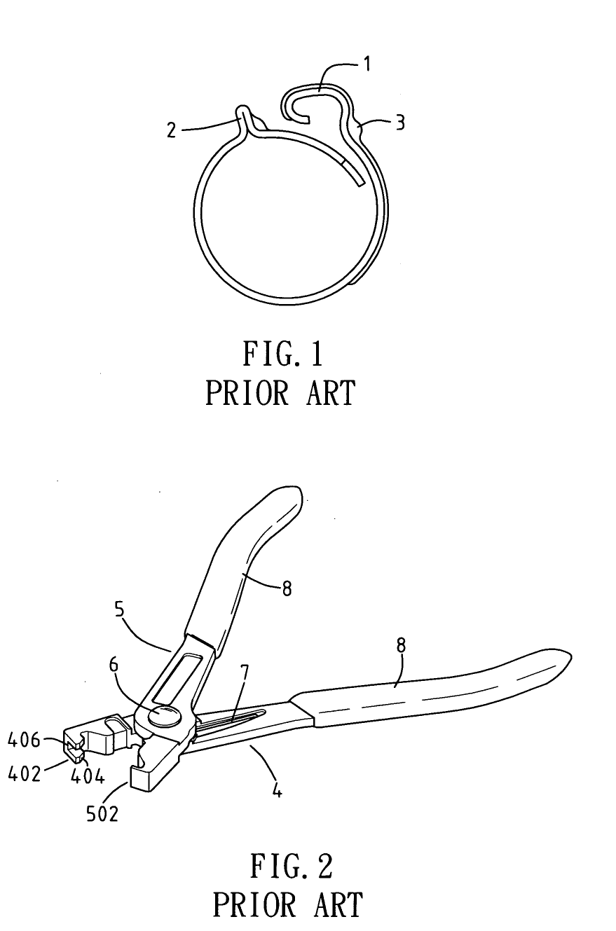

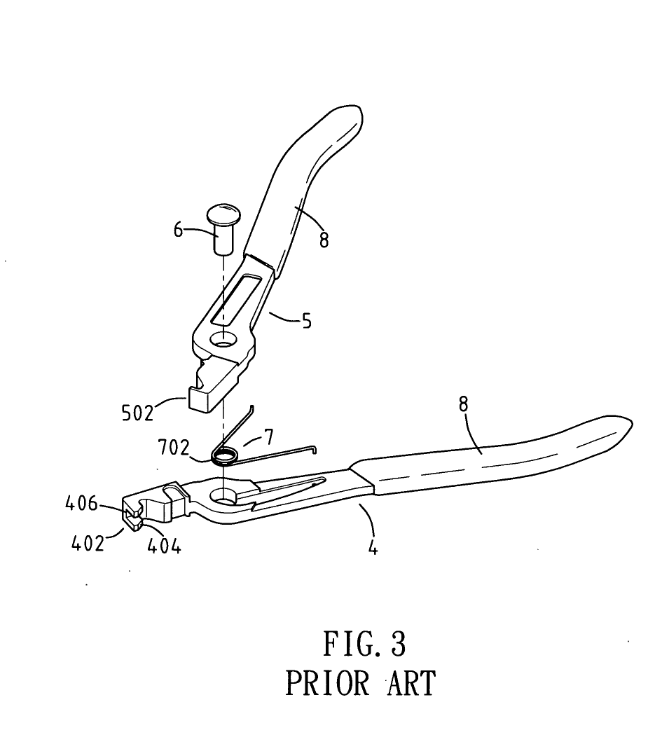

### DETAILED DESCRIPTION OF THE PREFERRED EMBODIMENT

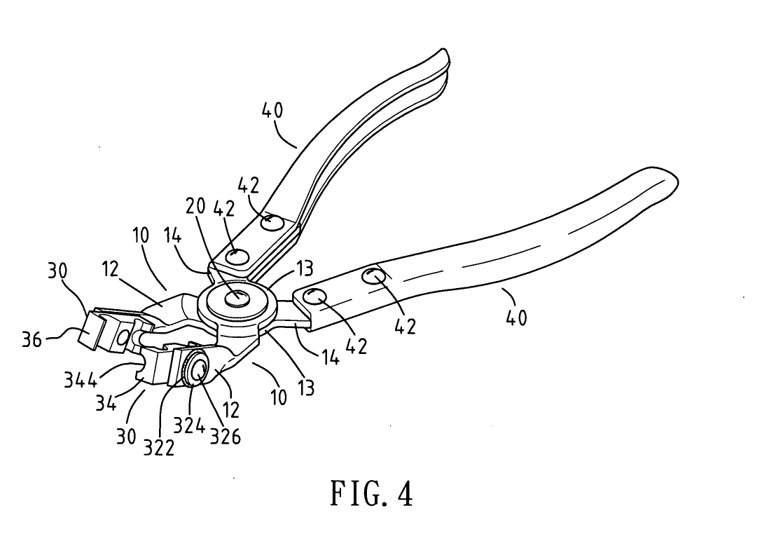

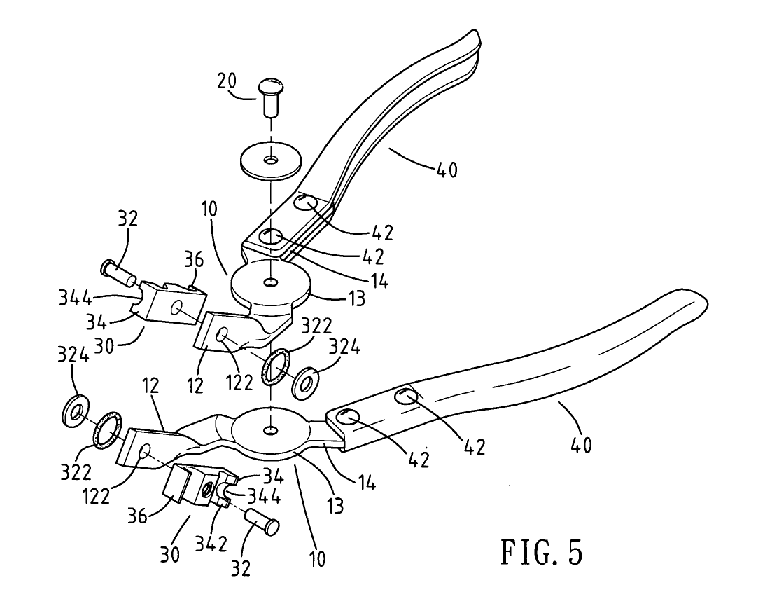

Referring to FIGS. 4 and 5, the tool for applying and removing a band clamp of the present invention comprises two parts 10 and each part 1 has a connection section 12 and a handle section 14. A disk portion 13 is formed at the mediate portion of each part 10 and the two respective disk portions 13 of the two parts 10 are overlapped with each other, a pin 20 extends through the two respective disk portions 13 so as to pivotably connected the two parts 10. Each handle section 14 is connected with a grip 40 by rivets 42.

Two applying members 30 are respectively and pivotably connected to the two respective connection sections 12 of the two parts 10. Each connection section 12 has a through hole 122 and each applying member 30 has a passage so that a rivet 32 extends through the passage, the through hole 122, a flexible ring 322 and a washer 324. A distal end of each rivet 32 is hammered to form an enlarged head 326 which presses the washer 324 so as to rotatably position the applying member 30 to the connection section 12.

Each applying member 30 has a first working end 34 and a second working end 36. The first working end 34 has an inclined surface 342 and a recess 344 defined in the inclined surface 342. The second working end 36 is a plate. The two applying members 30 are located such that the first working end 34 of one applying member 30 faces the second working end 36 of the other applying member 30.

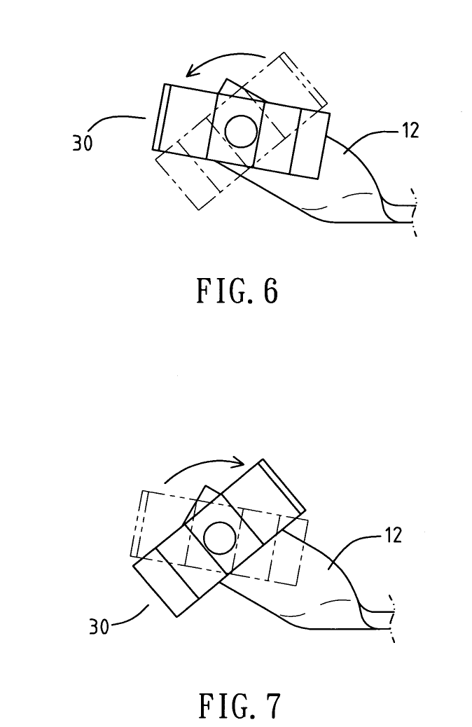

As shown in FIGS. 6 and 7, the two applying members 30 can be pivoted about the two respective rivets 32 so that the user does not need to adjust the positions of the grips 40 and just rotate the applying members 30 to reach the band clamp (not shown).

While we have shown and described the embodiment in accordance with the present invention, it should be clear to those skilled in the art that further embodiments may be made without departing from the scope of the present invention.

What is claimed is:

1. A tool for applying and removing a band clamp, comprising:
two parts which are pivotably connected with each other by a pin which extends through two respective mediate portions of the two parts, each part having a connection section and a handle section, and
two applying members respectively and pivotably connected to the two respective connection sections of the two parts, each applying member having a first working end and a second working end, the first working end having an inclined surface and a recess defined in the inclined surface, the second working end being a plate, the two applying members being located such that the first working end of one applying member faces the second working end of the other applying member.

2. The tool as claimed in claim 1, wherein each connection section has a through hole and each applying member has a passage so that a rivet extends through the passage, the through hole, a flexible ring and a washer, a distal end of each rivet is hammered to form an enlarged head which presses the washer so as to rotatably position the applying member to the connection section.

3. The tool as claimed in claim 1, wherein a disk portion is formed at the mediate portion of each part and the two respective disk portions of the two parts are overlapped with each other, the pin extends through the two respective disk portions.

4. The tool as claimed in claim 1, each handle section is connected with a grip by rivets.
